(19) United States
(12) Patent Application Publication
(10) Pub. No.: US 2026/0138312 A1
(43) Pub. Date: May 21, 2026

(54) VEHICLE INTERIOR MATERIAL WITH EXCELLENT FLEXURAL STRENGTH AND HEAT RESISTANCE, METHOD OF MANUFACTURING SAME, AND MOLDING DIE FOR SAME

(71) Applicants: Hyundai Motor Company, Seoul (KR); Kia Corporation, Seoul (KR); HUVIS CORPORATION, Seoul (KR)

(72) Inventors: Joon Yong Song, Hwaseong (KR); Oh Deok Kwon, Hwaseong (KR); Hong Chan Jeon, Hwaseong (KR); Mi Jung Yun, Hwaseong (KR); Seul Yi, Hwaseong (KR); Mee Huh, Daejeon (KR); Kwang Hee Lee, Daejeon (KR); Young Hoon Seo, Daejeon (KR)

(21) Appl. No.: 19/268,750

(22) Filed: Jul. 14, 2025

(30) Foreign Application Priority Data
Nov. 19, 2024 (KR) 10-2024-0164760

(51) Int. Cl. B29C 43/36; B29C 33/42; B29C 43/00; B29K 67/00; B29K 105/04; B29L 31/30; B32B 3/30; B32B 5/18

(52) U.S. Cl. CPC B29C 43/36; B29C 33/42; B29C 43/003; B32B 3/30; B32B 5/18; B29K 2067/003; B29K 2105/04; B29K 2995/0017; B29L 2031/3005; B32B 2255/102; B32B 2266/0264; B32B 2307/306; B32B 2307/718; B32B 2307/7376; B32B 2605/003

(57) ABSTRACT

The disclosure relates to a molding die used for creating vehicle interior materials. The die consists of a lower and an upper part, each with specific flat and shaped sections that fit together to form a molding area. This area ensures precise distances between parts for optimal molding. The resulting vehicle interior material features a flat region with protruding sections, where the flat region is thicker. The material is composed of a foam sheet with various layers, including a coating, surface, and back layer. It uses recycled and virgin polyethylene terephthalate, offering high crystallinity and heat resistance. The method involves preheating the material and press molding it at controlled temperatures and times. This process enhances the material's durability and structural integrity.

### CROSS-REFERENCE TO RELATED APPLICATION

This application claims, under 35 U.S.C. § 119 (a), the benefit of Korean Patent Application No. 10-2024-0164760, filed on Nov. 19, 2024, the entire contents of which are incorporated herein by reference.

### BACKGROUND

### Technical Field

The present disclosure relates to a vehicle interior material with excellent flexural strength and heat resistance, a method of manufacturing the same, and a molding die for the same.

### Background

Materials for use in vehicle interiors include polypropylene (PP) boards, natural fiber-reinforced boards, glass fiber-reinforced polypropylene (PP) boards, and polyurethane foam as bases, and polyethylene terephthalate (PET) nonwoven fabrics are used as the cover and backing materials.

In the fields of vehicle interior materials, there is a growing need to use lightweight materials to reduce fuel consumption or employ materials made from recycled materials to meet recycling regulations in line with recent eco-friendly trends.

Techniques using foam sheets for weight reduction are also being actively explored, but there is a problem in that parts manufactured by cold molding using conventional dies do not satisfy both rigidity and heat resistance. Cold molding enables formation of deep shapes, but is problematic because the curved shape collapses or rigidity decreases after heat resistance evaluation at about 80° C. Although the problems may be alleviated by hot molding referring to other industrial products, this is difficult in practice because it requires investment in new facilities, such as replacing the entire production line, etc.

Meanwhile, polyethylene terephthalate (PET), the main raw material for foam sheets, is widely used in beverage containers, food containers, etc., but as environmental pollution and global warming issues have arisen recently, a movement to use recycled materials is taking place across industries. However, in cases in which foam sheets are manufactured from recycled materials, properties thereof may deteriorate.

### SUMMARY OF THE DISCLOSURE

Various embodiments of the present disclosure provide a vehicle interior material with both flexural strength and heat resistance satisfying required levels, a method of manufacturing the same, and a molding die for the same.

Various embodiments of the present disclosure provide a vehicle interior material having good physical properties while using recycled raw materials, a method of manufacturing the same, and a molding die for the same.

Various embodiments of the present disclosure are not limited to the foregoing. The objects of the present disclosure will be able to be clearly understood through the following description and to be realized by the means described in the claims and combinations thereof.

In some embodiments, a molding die for a vehicle interior material may include a lower die including a first flat portion and a plurality of convex portions protruding from the first flat portion and an upper die including a second flat portion and a plurality of concave portions recessed from the second flat portion.

A molding area may be formed by die spotting of the lower die and the upper die by inserting the convex portions into the concave portions.

The molding area may satisfy Condition 1 below.

$${G}_{1} > {G}_{2} \qquad [ Condition 1 ]$$

In Condition 1, G₁ represents a distance between the first flat portion and the second flat portion and G₂ represents a distance between the convex portion and the concave portion.

In die spotting of the lower die and the upper die, the distance between the first flat portion and the second flat portion may be 2.5 mm or more.

In die spotting of the lower die and the upper die, the distance between the convex portion and the concave portion may be 2.0 mm or less.

The molding area may satisfy Condition 2 below.

$${G}_{1} - {G}_{2} > 1 mm \qquad [ Condition 2 ]$$

In Condition 2, G₁ represents a distance between the first flat portion and the second flat portion and G₂ represents a distance between the convex portion and the concave portion.

The molding area may satisfy Condition 3 below.

$${R}_{1} \leq 3 mm \qquad [ Condition 3 ]$$

In Condition 3, R₁ represents a radius of curvature of a corner of the concave portion.

The molding area may satisfy Condition 4 below.

$$0 \leq {R}_{2} \leq 0.3 mm \qquad [ Condition 4 ]$$

In Condition 4, R₂ represents a radius of curvature of a corner of the convex portion.

In some embodiments, a vehicle interior material, which is molded using the molding die described above, may include a first region and a plurality of second regions protruding from the first region, in which a thickness of the first region is greater than a thickness of the second region.

The first region may be flat.

The thickness of the first region may be 3.0 mm or more.

The thickness of the second region may be 2.5 mm or less.

A difference between the thickness of the first region and the thickness of the second region may be 1 mm or more.

The vehicle interior material may include a foam sheet including foam cells, a coating layer disposed on a surface of the foam sheet, a surface layer disposed on a surface of the coating layer, and a back layer disposed on another surface of the foam sheet.

The areal weight of the foam sheet may be 300 g/m² to 700 g/m².

The areal weight of the coating layer may be 70 g/m² to 300 g/m².

The areal weight of the surface layer may be 150 g/m² to 500 g/m².

The areal weight of the back layer may be 60 g/m² to 280 g/m².

The foam sheet may be configured such that an aspect ratio of the foam cells in the second region is longer than an aspect ratio of the foam cells in the first region.

The foam sheet may have an isophthalic acid (IPA) content of 0.01 mol % to 3 mol % and a melting point of 245° C. or more.

The foam sheet may include polyethylene terephthalate (PET), and the polyethylene terephthalate may include 1 to 70 wt % of recycled polyethylene terephthalate and 30 to 99 wt % of virgin polyethylene terephthalate.

The virgin polyethylene terephthalate may have an intrinsic viscosity (IV) of 0.7 dl/g or more, a melting point of 250° C. or more, and 60 wt % or more of a molecule with a molecular weight of 10,000 g/mol or more as represented by a differential molecular weight distribution.

The vehicle interior material may have crystallinity of 20% or more.

The bending load of the first region may be 10 N or more.

The vehicle interior material may have a heat-resistant deflection of 10% or less.

In some embodiments, a method of molding a vehicle interior material may include preheating a vehicle interior material including a foam sheet and performing press molding by pressing the preheated vehicle interior material between the lower die and the upper die.

Preheating the vehicle interior material may include heating the vehicle interior material at 250° C. to 350° C. for 85 seconds to 150 seconds so that a surface temperature of the vehicle interior material is 190° C. to 250° C.

Performing the press molding may include placing the preheated vehicle interior material between the lower die and the upper die and performing press molding at 0° C. to 40° C. for 40 seconds to 80 seconds.

As discussed, the method and system suitably include use of a controller or processer.

In another embodiment, vehicles are provided that comprise an apparatus as disclosed herein.

### BRIEF DESCRIPTION OF THE DRAWINGS

The above and other features of the present disclosure will now be described in detail with reference to certain various embodiments thereof illustrated in the accompanying drawings which are given hereinbelow by way of illustration only, and thus are not limitative of the present disclosure, and wherein:

FIG. 1 shows a vehicle interior material according to some embodiments of the present disclosure;

FIG. 2 shows a molding die for manufacturing a vehicle interior material according to some embodiments of the present disclosure;

FIG. 3 shows a lower die according to some embodiments of the present disclosure;

FIG. 4 shows an upper die according to some embodiments of the present disclosure;

FIG. 5 shows a stack structure of the vehicle interior material according to some embodiments of the present disclosure;

FIG. 6 shows the specifications of the molding die, molding conditions, and properties of the vehicle interior material according to Examples 1 to 4 and Comparative Examples 1 to 6; and

FIG. 7 shows the composition of the foam sheet, properties of the foam sheet, molding conditions, and properties of the vehicle interior material according to Examples 5 to 7 and Comparative Examples 7 to 9.

### DETAILED DESCRIPTION

The above and other objects, features and advantages of the present disclosure will be more clearly understood from the following various embodiments taken in conjunction with the accompanying drawings. However, the present disclosure is not limited to the embodiments disclosed herein and may be modified into different forms. Various embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

The term “die spotting” herein refers to the process of aligning and verifying the contact between the upper and lower dies to ensure precise mating of the convex and concave portions, thereby forming a uniform molding area with controlled gap distances for optimal material flow and structural integrity of the molded product.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The term “vehicle interior material” herein refers to materials used in the construction and design of a vehicle's interior components, such as seats, dashboards, panels, and flooring, which may include fabrics, foams, plastics, and composites designed for durability, comfort, and aesthetic appeal.P

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous and includes all values from the minimum value of said range to the maximum value thereof, unless otherwise indicated. Moreover, when such a range pertains to integer values, all integers including the minimum value to the maximum value are included, unless otherwise indicated.

FIG. 1 shows a vehicle interior material 1 according to the present disclosure. The vehicle interior material 1 may include a flat first region A and a plurality of second regions B protruding from the first region A.

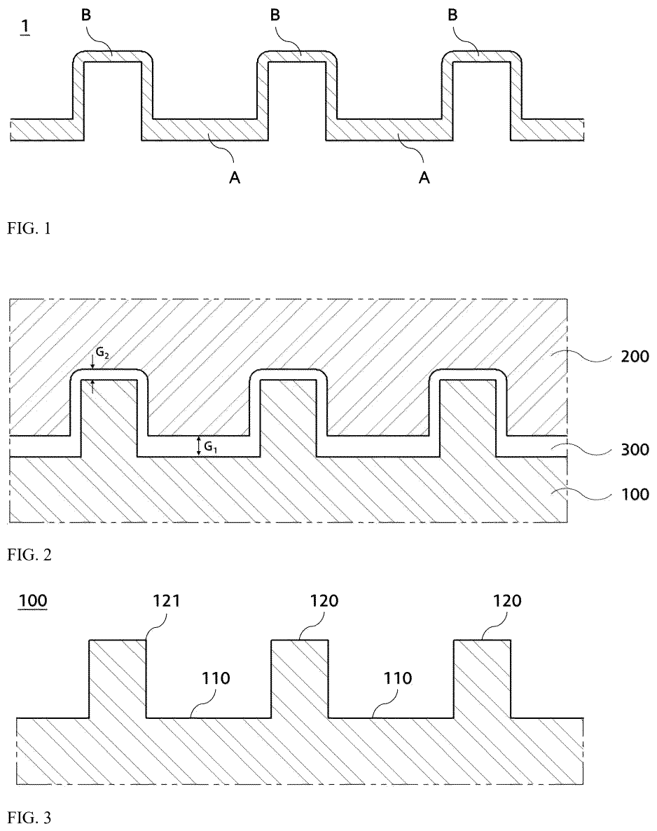

FIG. 2 shows a molding die for manufacturing the vehicle interior material 1 according to the present disclosure. The molding die may include a lower die 100 and an upper die 200, and a molding area 300 may be formed by die spotting of the lower die 100 and the upper die 200.

FIG. 3 shows a lower die 100 according to the present disclosure. The lower die 100 may include a first flat portion 110 and a plurality of convex portions 120 protruding from the first flat portion 100.

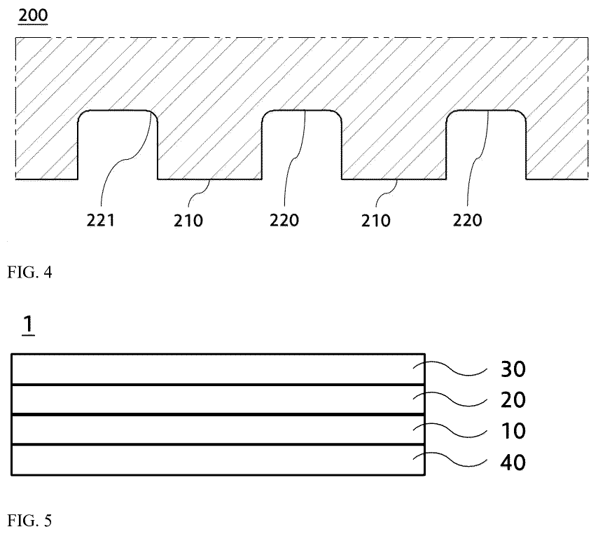

FIG. 4 shows an upper die 200 according to the present disclosure. The upper die 200 may include a second flat portion 210 and a plurality of concave portions 220 recessed from the second flat portion 210.

The present disclosure is intended to provide a molding die of improving both flexural strength and heat resistance of the vehicle interior material 1 even when cold molding is performed.

Specifically, the molding area 300 may satisfy Condition 1 below.

$${G}_{1} > {G}_{2} \qquad [ Condition 1 ]$$

In Condition 1, G₁ represents the distance between the first flat portion 110 and the second flat portion 210 and G₂ represents the distance between the convex portion 120 and the concave portion 220.

In the molding area 300, the first region A of the vehicle interior material 1 may be press-molded by the first flat portion 110 and the second flat portion 210, and the second region B of the vehicle interior material 1 may be press-molded by the convex portion 120 and the concave portion 220. The thickness of the first region A may be greater than the thickness of the second region B. The present disclosure is characterized in that flexural strength of the vehicle interior material 1 is enhanced by increasing the thickness of the first region A, and heat resistance of the vehicle interior material 1 is improved by forming the second region B thinner than the first region A.

In die spotting of the lower die 100 and the upper die 200, the distance G₁ between the first flat portion 110 and the second flat portion 210 may be 2.5 mm or more. The upper limit of the distance G₁ is not particularly limited and may be 5 mm or less or 4 mm or less. The thickness of the first region A press-molded by the first flat portion 110 and the second flat portion 210 may be 3.0 mm or more. The upper limit of the thickness is not particularly limited and may be, for example, 5 mm or less or 4 mm or less. When the distance G₁ between the first flat portion 110 and the second flat portion 210 is 2.5 mm or more, the thickness of the first region A becomes a desired level, thereby improving flexural strength of the vehicle interior material 1.

In die spotting of the lower die 100 and the upper die 200, the distance G₂ between the convex portion 120 and the concave portion 220 may be 2.0 mm or less. The lower limit of the distance G₂ is not particularly limited and may be 1 mm or more or 1.5 mm or more. The thickness of the second region B press-molded by the convex portion 120 and the concave portion 220 may be 2.5 mm or less. The lower limit of the thickness is not particularly limited and may be, for example, 1 mm or more or 1.5 mm or more. When the distance G₂ between the convex portion 120 and the concave portion 220 is 2.0 mm or less, the thickness of the second region B becomes a desired level, thereby improving heat resistance of the vehicle interior material 1. The heat resistance indicates a heat-resistant deflection, and the heat-resistant deflection may be a change in height of the second region B when performing a series of cycles of applying a predetermined amount of heat to the vehicle interior material 1 and cooling the same, which will be described later.

The molding area 300 may satisfy Condition 2 below.

$${G}_{1} - {G}_{2} > 1 mm \qquad [ Condition 2 ]$$

In Condition 2, G₁ represents the distance between the first flat portion 110 and the second flat portion 210 and G₂ represents the distance between the convex portion 120 and the concave portion 220. The upper limit of G₁-G₂ is not particularly limited and may be, for example, 3 mm or less or 2.5 mm or less.

The difference between the thickness of the first region A and the thickness of the second region B may be 1 mm or more. The upper limit of the difference in the thickness is not particularly limited and may be, for example, 3 mm or less or 2.5 mm or less.

When Condition 2 is satisfied, the difference in thickness between the first region A and the second region B of the vehicle interior material 1 becomes an appropriate level, so that flexural strength and heat resistance of the vehicle interior material 1 may be improved in a balanced manner.

The molding area 300 may satisfy Condition 3 and/or Condition 4 below, further improving heat resistance of the vehicle interior material 1.

$${R}_{1} \leq 3 mm \qquad [ Condition 3 ]$$

In Condition 3, R₁ represents the radius of curvature of the corner 221 of the concave portion 220. The lower limit of the radius of curvature R₁ is not particularly limited and may be, for example, 1 mm or more or 2 mm or more.

$$0 \leq {R}_{2} \leq 0.3 mm \qquad [ Condition 4 ]$$

In Condition 4, R₂ represents the radius of curvature of the corner 121 of the convex portion 120.

When Conditions 3 and 4 are satisfied, the inner surface of the second region B of the vehicle interior material 1 is formed to be close to a right angle and the outer surface thereof is formed to be round, thereby reducing the heat-resistant deflection of the second region B.

FIG. 5 shows the stack structure of the vehicle interior material 1 according to the present disclosure. The vehicle interior material 1 may include a foam sheet 10 including foam cells, a coating layer 20 disposed on a surface of the foam sheet 10, a surface layer 30 disposed on a surface of the coating layer 20, and a back layer 40 disposed on another surface of the foam sheet 10.

The foam sheet 10, the coating layer 20, the surface layer 30, and the back layer 40 may all include the same material, for example, polyester. The vehicle interior material 1 may be easily recycled because each layer includes the same material and thus no separation process is required.

The polyester may include one or more of polyethylene terephthalate (PET), polybutylene terephthalate (PBT), polylactic acid (PLA), polyglycolic acid (PGA), polyethylene adipate (PEA), polyhydroxyalkanoate (PHA), polytrimethylene terephthalate (PTT) and polyethylene naphthalate (PEN). Preferably, the polyester may include polyethylene terephthalate (PET).

Since the foam sheet 10 includes foam cells, the weight of the vehicle interior material 1 may be reduced.

The number of foam cells of the foam sheet 10 may include 1 to 30 cells, 3 to 25 cells, or 3 to 20 cells per mm². Also, the average size of the foam cells may be 10 μm to 800 μm, or 30 μm to 600 μm.

The foam sheet 10 may be configured such that an aspect ratio of the foam cells in the second region B is longer than an aspect ratio of the foam cells in the first region A. The aspect ratio may be the ratio of the long-axis length to the short-axis length of the foam cell and may be calculated by dividing the long-axis length of the foam cell by the short-axis length. The long-axis length may be the length measured along the longest portion of the foam cell, and for example, if the foam cell is oval, the long-axis length may be the longest diameter of the oval. The short-axis length may be the length of the shortest portion of the foam cell measured in a direction perpendicular to the long-axis length.

The foam sheet 10 includes a plurality of cells, and after being molded into a vehicle material, the aspect ratio of the foam cells in the second region B of the foam sheet 10 may be greater than the aspect ratio of the foam cells in the first region A of the foam sheet 10.

Before molding, the foam cells in the first region A and the foam cells in the second region B have the same size. Since the foam cells are compressed during molding, the long-axis length of the foam cells generally increases but the short-axis length of the foam cells generally decreases. After molding, the thickness of the second region B is less than that of the first region A, the second region B is more compressed during molding and becomes thinner, so the foam cells of the second region B are also compressed more during molding.

Compared to the first region A, the long-axis length to the short-axis length of the foam cells of the second region B is further increased, or the short-axis length to the long-axis length thereof is further reduced.

The long-axis length of the foam cells of the first region A may be 200 μm to 600 μm, and the short-axis length thereof may be 60 μm to 160 μm. The aspect ratio of the foam cells of the first region A may be 1.25 to 10.

The long-axis length of the foam cells of the second region B may be 200 μm to 600 μm, and the short-axis length thereof may be 30 μm to 100 μm. The aspect ratio of the foam cells of the second region B may be 2 to 20.

The areal weight of the foam sheet 10 may be 300 g/m² to 700 g/m². When the areal weight of the foam sheet 10 falls within the above numerical range, both lightness and rigidity of the vehicle interior material 1 may be improved.

The foam sheet 10 may include polyethylene terephthalate (PET). Specifically, the foam sheet 10 may include 1 to 70 wt % of recycled polyethylene terephthalate and 30 to 99 wt % of virgin polyethylene terephthalate. If the amount of the recycled polyethylene terephthalate is less than 1 wt %, the effect of using recycled materials cannot be obtained, whereas if it exceeds 70 wt %, physical and chemical properties of the vehicle interior material 1 may deteriorate.

The virgin polyethylene terephthalate may have an intrinsic viscosity (IV) of 0.7 dl/g or more. The upper limit of the intrinsic viscosity is not particularly limited and may be, for example, 1.2 dl/g or less.

The virgin polyethylene terephthalate may have a melting point of 250° C. or more. The upper limit of the melting point is not particularly limited and may be, for example, 260° C. or less.

The virgin polyethylene terephthalate may have 60 wt % or more of a molecule with a molecular weight of 10,000 g/mol or more as represented by a differential molecular weight distribution. The upper limit of the proportion of the molecule is not particularly limited and may be, for example, 90 wt % or less, 80 wt % or less, or 70 wt % or less.

When the properties of the virgin polyethylene terephthalate fall within the above numerical ranges, deterioration of physical and chemical properties of the vehicle interior material 1 due to the use of recycled polyethylene terephthalate may be prevented.

The foam sheet 10 may have an isophthalic acid (IPA) content of 0.01 mol % to 3 mol % based on 100 mol % of the acid component. The foam sheet 10 contains isophthalic acid, thus improving heat resistance and chemical durability of the recycled polyethylene terephthalate and imparting amorphousness, thereby improving adhesive strength to a certain level.

The foam sheet 10 may have a melting point of 245° C. or more. The upper limit of the melting point is not particularly limited and may be, for example, 260° C. or less.

The foam sheet 10 may have hydrophilic performance, waterproof performance, flame retardant performance, or ultraviolet blocking performance, and may further include functional additives such as a surfactant, a hydrophilic agent, a flame retardant, a heat stabilizer, a cell size expander, an infrared attenuator, a plasticizer, a fireproof chemical, a pigment, an elastic polymer, an extrusion aid, an antioxidant, a nucleating agent, an anti-static agent, and a UV absorber.

The coating layer 20 may serve to adhere the foam sheet 10 and the surface layer 30. The coating layer 20 enables deep drawing when molding the vehicle interior material 1 by cold molding and is able to prevent separation of the foam sheet 10 and the surface layer 30. Also, the coating layer 20 may serve to improve sound insulation performance.

The areal weight of the coating layer 20 may be 70 g/m² to 300 g/m².

The surface layer 30 and the back layer 40 may each include nonwoven fabric. The type of nonwoven fabric is not particularly limited and may include a needle-punched nonwoven fabric when considering sound insulation and sound absorption performance and prevention of separation between layers.

The areal weight of the surface layer 30 may be 150 g/m² to 500 g/m², and the areal weight of the back layer 40 may be 60 g/m² to 280 g/m².

The crystallinity of the vehicle interior material 1 may be 20% or more. The upper limit of crystallinity is not particularly limited and may be, for example, 30% or less. When the crystallinity is 20% or more, the strength of the vehicle interior material 1 may be increased.

The bending load of the vehicle interior material 1 may be 10 N or more. The bending load may mean a maximum bending load of the vehicle interior material. The maximum bending load may be a property for the first region A. The maximum bending load may be measured according to KS M ISO 178 with reference to KSF3230.

The heat-resistant deflection of the vehicle interior material 1 may be 10% or less. The heat-resistant deflection may be a change in height of the second region B before and after heat resistance cycle evaluation for the vehicle interior material 1. The heat resistance cycle evaluation is conducted by repeating 3 cycles each including leaving for 3 hours at 80±2° C., 1 hour at 23±2° C., 3 hours at −30±2° C., 1 hour at 23±2° C., 15 hours at 50±2° C. and 95% to 100% RH, and 1 hour at 23±2° C.

A method of molding a vehicle interior material using the molding die according to the present disclosure may include preheating a vehicle interior material 1 including the foam sheet 10 and performing press molding by placing and pressing the preheated vehicle interior material 1 between a lower die 100 and an upper die 200.

The molding process may be a cold molding process.

Preheating the vehicle interior material may include heating the vehicle interior material 1 to 250° C. to 350° C. for 85 seconds to 150 seconds so that the surface temperature of the vehicle interior material 1 is 190° C. to 250° C. If the preheating temperature is low or the preheating time is short, crystallinity of the vehicle interior material 1 may decrease and the heat-resistant deflection may increase.

Performing the press molding may include placing and pressing the preheated vehicle interior material 1 between the lower die 100 and the upper die 200 and performing press molding at 0° C. to 40° C. for 40 seconds to 80 seconds. The vehicle interior material 1 may be formed into a desired shape only when the press molding conditions are satisfied.

A better understanding of the present disclosure may be obtained through the following examples and comparative examples. However, these examples are not to be construed as limiting the technical spirit of the present disclosure.

### Example 1

A composite material was prepared by stacking layers each having the areal weight and thickness as shown in Table 1 below. Table 1 also shows the thickness of the first region and the thickness of the second region after molding the composite material.

TABLE 1

| | Before molding | | After molding | |
|---|---|---|---|---|
| | Areal weight | Thickness | Thickness of first | Thickness of second |
| Classification | [g/m²] | [mm] | region [mm] | region [mm] |
| Surface layer | 300 | 1.0 | 0.6 | 0.4 |
| Coating layer | 200 | 0.15 | 0.1 | 0.1 |
| Foam sheet | 480 | 3.00 | 2.7 | 1.4 |
| Back layer | 150 | 0.50 | 0.3 | 0.2 |
| Total | 1,130 | 4.65 | 3.7 | 2.1 |

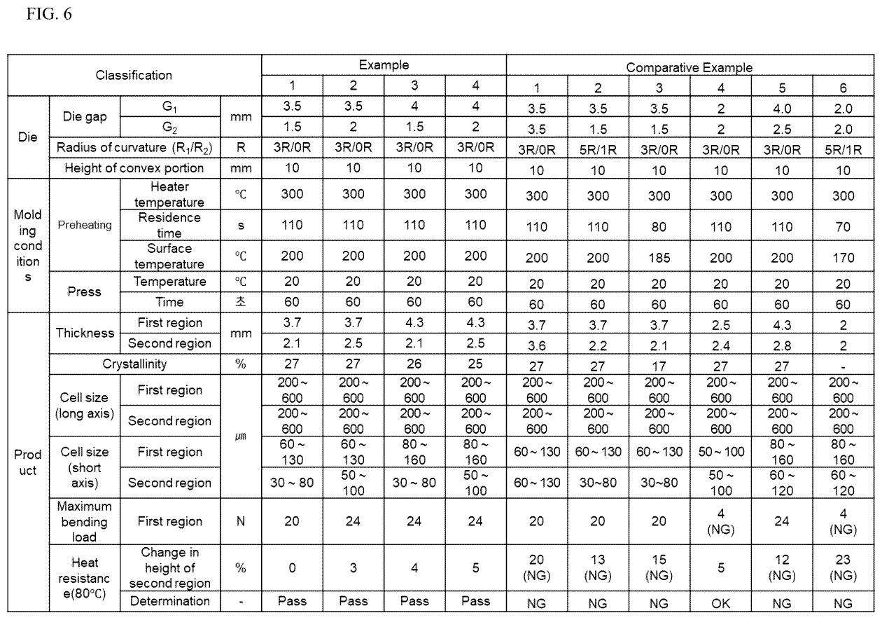

FIG. 6 shows the specifications of the molding die, the molding conditions, and the properties of the vehicle interior material according to Examples 1 to 4 and Comparative Examples 1 to 6.

A vehicle interior material was manufactured by subjecting the composite material to cold molding using a molding die with the specifications shown in FIG. 6.

### Examples 2 to 4 and Comparative Examples 1 to 6

Respective vehicle interior materials were manufactured in the same manner as in Example 1, with the exception that the conditions for cold molding were changed as shown in FIG. 6.

The properties were evaluated as follows.
Crystallinity: The melting enthalpy at the melting temperature and the crystallization enthalpy at the cooling crystallization temperature were measured using differential scanning calorimetry (DSC), and crystallinity was calculated according to the following equation.
Crystallinity=(ΔHm−ΔHc)/ΔHm (in which ΔHm represents melting enthalpy, ΔHc represents crystallization enthalpy, and ΔHm represents standard melting enthalpy (140 J/g))
Cell size: The long- and short-axis lengths of the foam cells were measured using a scanning electron microscope (SEM).
Maximum bending load: The radii of a pressure rod and a support and a test speed were determined according to KS M ISO 178 with reference to KSF3230, and the maximum bending load of the first region was measured in the test specimen.
80° C. heat resistance: After maintaining the vehicle interior material in the same state as in an actual vehicle, 3 cycles were performed under the condition that the following conditions were set as 1 cycle, and then a change in height of the second region was measured using the following relation.

Heat resistance cycle: leaving for 3 hours at 80±2° C., 1 hour at 23±2° C., 3 hours at −30±2° C., 1 hour at 23±2° C., 15 hours at 50±2° C. and 95% to 100% RH, and 1 hour at 23±2° C.

|Hb−Ha|/Ha×100 (in which Ha represents the height of the second region before heat resistance cycle evaluation and Hb represents the height of the second region after heat resistance cycle evaluation)

Referring to FIG. 6, in Examples 1 to 4, the gap G₁ of the molding die corresponding to the first region was designed to be 2.5 mm or more, so that the maximum bending load was 20 N or more.

Also, by designing the gap G₂ of the molding die corresponding to the second region to be 2 mm or less and to be smaller than the gap of the molding die corresponding to the first region, a heat-resistant deflection of 5% or less was exhibited.

In Comparative Example 1, the heat-resistant deflection exceeded 10% because G₁ and G₂ were the same, and in particular, G₂ was thicker than 2 mm.

In Comparative Example 2, the heat-resistant deflection exceeded 10% because R₁ and R₂ were large.

Comparative Example 3 exhibited low crystallinity less than 20% because the residence time in the preheating step was less than 85 seconds, and the surface temperature of the vehicle interior material was less than 190° C. Also, the heat-resistant deflection exceeded 10%.

In Comparative Example 4, the maximum bending load was less than 10 N because G₁ and G₂ were the same, and in particular, G₁ was thinner than 2.5 mm.

In Comparative Example 5, the heat-resistant deflection exceeded 10% because G₂ was thicker than 2 mm.

In Comparative Example 6, the heat-resistant deflection exceeded 10% because G₁ and G₂ were the same, G₁ was thinner than 2.5 mm, R₁ and R₂ were large, the residence time in the preheating step was less than 85 seconds, and the surface temperature of the vehicle interior material was less than 190° C.

### Examples 5 to 7 and Comparative Examples 7 to 9

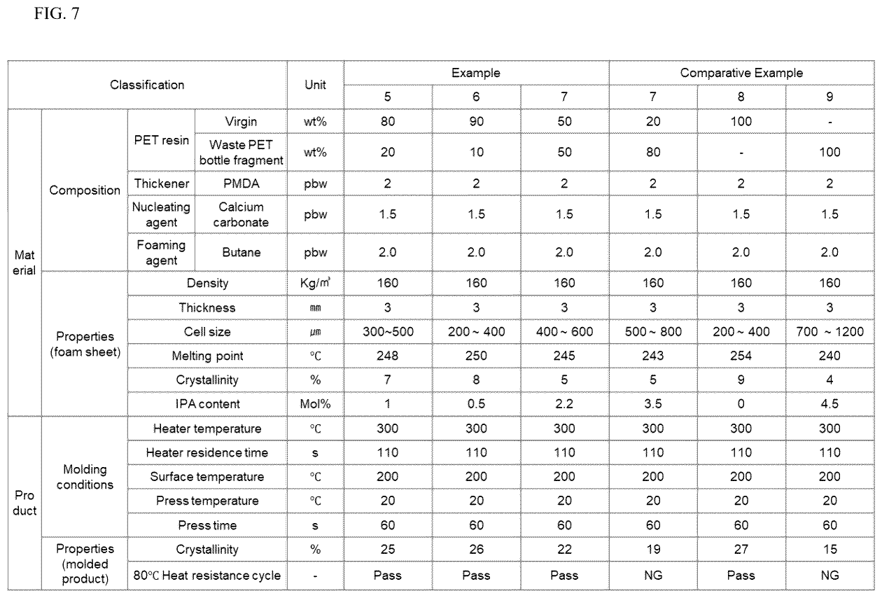

FIG. 7 shows the composition of the foam sheet, the properties of the foam sheet, the molding conditions, and the properties of the vehicle interior material according to Examples 5 to 7 and Comparative Examples 7 to 9.

Virgin polyethylene terephthalate having an intrinsic viscosity (IV) of 0.8 dl/g, a melting point of 256° C., a weight average molecular weight of 67,000 g/mol, and 60 wt % or more of a molecule with a molecular weight of 10,000 g/mol or more as represented by a differential molecular weight distribution was used. Waste PET bottle fragments were used as recycled polyethylene terephthalate. The waste PET bottle fragments used had an intrinsic viscosity (IV) of 0.78 dl/g and a melting point of 246° C.

The same molding die as in Example 1 was used.

The properties were evaluated as follows.
Intrinsic viscosity (IV): The sample was dissolved at a concentration of 0.5 wt % in a mixed solution of phenol and tetrachloroethane (mixing ratio=1:1 by volume), followed by measurement at 35° C. using an Ubbelohde viscometer.
Melting point: Measurement was performed in the range of 40° C. to 270° C. (heating at 20° C./min) using a differential scanning calorimeter (Perkin Elmer, DSC-7).
Molecular weight: The sample was dissolved in a mixed solution of chloroform and phenol (mixing ratio=1:1 by volume), followed by measurement at 254 nm using gel permeation chromatography (GPC, analyzer: HLC-8320). The standard sample was polymethyl methacrylate (PMMA).
Density: Measurement was performed under KS M ISO 845 conditions using EW-300SG from Alfa Mirage.
Cell size: The long- and short-axis lengths of the cells were measured using a scanning electron microscope (SEM), and the average value thereof was used as the cell size.
IPA content: Measurement was performed using NMR (nuclear magnetic resonance) analysis.

Referring to FIG. 7, the foam sheets of Examples 5 to 7 exhibited low density and foam cells of 600 μm or less and had an IPA content of 3 mol % or less, a melting point of 245° C. or more, and crystallinity of 4% to 10%. In addition, the molded products of Examples 5 to 7 had crystallinity greater than 20% even after cold molding and passed the 80° C. heat resistance cycle.

In particular, Example 6 exhibited the properties equivalent to those of Comparative Example 8 using only virgin polyethylene terephthalate.

Comparative Examples 7 and 9, using an excess of recycled polyethylene terephthalate, had large foam cell sizes, low melting points and crystallinity, and high IPA contents. In addition, the molded products of Comparative Examples 7 and 9 had low crystallinity and did not pass the 80° C. heat resistance cycle.

As is apparent from the foregoing, according to the present disclosure, it is possible to obtain a vehicle interior material with both flexural strength and heat resistance satisfying required levels.

In some embodiments, it is possible to obtain a vehicle interior material having good physical properties while using recycled raw materials.

The effects of the present disclosure are not limited to the foregoing. It should be understood that the effects of the present disclosure include all effects that can be inferred from the description of the present disclosure.

As described hereinbefore, although the embodiments have been described through limited examples and drawings, those skilled in the art will appreciate that various modifications and alterations are possible from the above description. For example, even when the described techniques are performed in an order different from the described method and/or even when the described components are linked or combined in a different form from the described method or are replaced or substituted by other components or equivalents, it is possible to achieve appropriate results. Therefore, other embodiments, other examples, and equivalents to the claims are also within the scope of the following claims.

What is claimed is:

1. A molding die for a vehicle interior material, the molding die comprising:
a lower die comprising a first flat portion and a plurality of convex portions protruding from the first flat portion; and
an upper die comprising a second flat portion and a plurality of concave portions recessed from the second flat portion,
wherein a molding area is formed by die spotting of the lower die and the upper die by inserting the convex portions into the concave portions, and
wherein the molding area satisfies Condition 1 below:
$${G}_{1} > {G}_{2} \qquad [ Condition 1 ]$$
in Condition 1, G₁ represents a distance between the first flat portion and the second flat portion, and G₂ represents a distance between the convex portion and the concave portion.

2. The molding die of claim 1, wherein, in the die spotting of the lower die and the upper die, the distance between the first flat portion and the second flat portion is about 2.5 mm or more, and the distance between the convex portion and the concave portion is about 2.0 mm or less.

3. The molding die of claim 1, wherein the molding area satisfies Condition 2 below:
$${G}_{1} - {G}_{2} > 1 mm \qquad [ Condition 2 ]$$
in Condition 2, G₁ represents a distance between the first flat portion and the second flat portion and G₂ represents a distance between the convex portion and the concave portion.

4. The molding die of claim 1, wherein the molding area satisfies Condition 3 below:
$${R}_{1} \leq 3 mm \qquad [ Condition 3 ]$$
in Condition 3, R₁ represents a radius of curvature of a corner of the concave portion.

5. The molding die of claim 1, wherein the molding area satisfies Condition 4 below:
$$0 \leq {R}_{2} \leq 0.3 mm \qquad [ Condition 4 ]$$
in Condition 4, R₂ represents a radius of curvature of a corner of the convex portion.

6. A vehicle interior material, which is molded using the molding die of claim 1 and comprising a first region and a plurality of second regions protruding from the first region, wherein the first region is flat, and wherein a thickness of the first region is greater than a thickness of the second region.

7. The vehicle interior material of claim 6, wherein the thickness of the first region is about 3.0 mm or more and the thickness of the second region is about 2.5 mm or less.

8. The vehicle interior material of claim 6, wherein a difference between the thickness of the first region and the thickness of the second region is about 1 mm or more.

9. The vehicle interior material of claim 6, wherein the vehicle interior material comprises a foam sheet comprising foam cells; a coating layer disposed on a surface of the foam sheet; a surface layer disposed on a surface of the coating layer; and a back layer disposed on an another surface of the foam sheet.

10. The vehicle interior material of claim 9, wherein:
an areal weight of the foam sheet is about 300 g/m² to 700 g/m²,
an areal weight of the coating layer is about 70 g/m² to 300 g/m²,
an areal weight of the surface layer is about 150 g/m² to 500 g/m², and
an areal weight of the back layer is about 60 g/m² to 280 g/m².

11. The vehicle interior material of claim 9, wherein the foam sheet is configured such that an aspect ratio of the foam cells in the second region is longer than an aspect ratio of the foam cells in the first region.

12. The vehicle interior material of claim 9, wherein the foam sheet has an isophthalic acid (IPA) content of about 0.01 to about 3 mol % and a melting point of about 245° C. or more.

13. The vehicle interior material of claim 9, wherein the foam sheet comprises polyethylene terephthalate (PET), and the polyethylene terephthalate comprises about 1 to 70 wt % of recycled polyethylene terephthalate and about 30 to 99 wt % of virgin polyethylene terephthalate.

14. The vehicle interior material of claim 13, wherein the virgin polyethylene terephthalate has an intrinsic viscosity (IV) of about 0.7 dl/g or more, a melting point of about 250° C. or more, and about 60 wt % or more of a molecule with a molecular weight of about 10,000 g/mol or more as represented by a differential molecular weight distribution.

15. The vehicle interior material of claim 6, having crystallinity of about 20% or more.

16. The vehicle interior material of claim 6, wherein a bending load of the first region is about 10 N or more.

17. The vehicle interior material of claim 6, wherein the vehicle interior material has a heat-resistant deflection of about 10% or less in which the heat-resistant deflection is a change in height of the second region before and after heat resistance cycle evaluation.

18. A method of molding a vehicle interior material using the molding die of claim 1, the method comprising:
preheating a vehicle interior material comprising a foam sheet; and
performing press molding by pressing the vehicle interior material between the lower die and the upper die.

19. The method of claim 18, wherein the preheating the vehicle interior material comprises heating the vehicle interior material at about 250° C. to 350° C. for about 85 seconds to 150 seconds so that a surface temperature of the vehicle interior material is about 190° C. to 250° C.

20. The method of claim 18, wherein the performing the press molding comprises placing the preheated vehicle interior material between the lower die and the upper die and performing press molding at about 0° C. to 40° C. for about 40 seconds to 80 seconds.
